(19) United States
(12) Patent Application Publication
(10) Pub. No.: US 2026/0186352 A1
(43) Pub. Date: Jul. 2, 2026

(54) CURVED OPTICAL DEVICES, AND METHODS FOR MAKING SAME

(71) Applicant: ALPHAMICRON INCORPORATED, Kent, OH (US)

(72) Inventors: Bahman Taheri, Shaker Heights, OH (US); Paul Luchette, Kent, OH (US)

(73) Assignee: ALPHAMICRON INCORPORATED, Kent, OH (US)

(21) Appl. No.: 19/127,343

(22) PCT Filed: Nov. 6, 2023
(86) PCT No.: PCT/US2023/078763

§ 371 Date: May 5, 2025

Related U.S. Application Data
(60) Provisional application No. 63/422,435, filed on Nov. 4, 2022.

(51) Int. Cl. G02F 1/1343; G02F 1/1333

(52) U.S. Cl. CPC G02F 1/13439; G02F 1/133305; G02F 2201/56; G02F 2203/48

(57) ABSTRACT

A curved variable transmission optical device (“VTOD”) includes a first substrate structure including a first transparent electrode provided over a first substrate, and a second substrate structure including a second transparent electrode provided over a second substrate. The VTOD includes an electro-optic material provided between the substrates, wherein each transparent electrode is interposed between its respective substrate and the electro-optic material. The first and second substrate structures retain a curved shape such that the VTOD is characterized by at least a first curvature. At least one transparent electrode includes a transparent hybrid conductor having a multilayer or gradient compositional structure. The transparent hybrid conductor includes a conductive polymer and may further include a supplemental conductor.

### CROSS-REFERENCE TO RELATED APPLICATIONS

This application claims priority to, and any other benefit of, U.S. Provisional Patent Application Ser. No. 63/422,435 entitled CURVED OPTICAL DEVICES, AND METHODS FOR MAKING SAME, filed Nov. 4, 2022, the entire disclosure of which is fully incorporated herein by reference.

### TECHNICAL FIELD

The present disclosure relates to optical devices, particularly optical devices including a curved or multicurved liquid crystal film structure.

### BACKGROUND

Liquid crystal (“LC”) electronic devices are optical devices that offer a low cost, low power consumption approach to active light management. Although LC electronic devices are well known for their use in displays, LC devices may be used to make light adjusting (sometimes called light adaptive) windows, lenses, visors, eyewear, mirrors, or the like. It is common for such applications to include some curvature. Whether stand-alone or laminated, an LC electronic device for light management may need to take on a desired curved shape. It is common practice to manufacture light management LC devices using flat substrates.

Unfortunately, it is difficult to conform or change a flat device to a curved configuration, particularly a multicurved configuration, because, among other reasons, it may require a change in the area to meet the topographic conditions. A change in overall surface area, for example by stretching, may damage the device. One may instead start from preformed curved substrates, but a finished LC device is more difficult to manufacture due in part to the complexities in applying various device layers uniformly to a curved substrate. Further, starting with preformed curved substrates may require specific molds or the like for each application. That is, each light management LC electronic device product must be individually tailored to account for the unique product properties, e.g., curvature, size, or the like. One product line may not be compatible with another.

Thus, there is a desire for curved or multicurved optical devices such as LC devices that are easily manufactured and maintain high device performance quality.

### SUMMARY

In accordance with an embodiment, a curved variable transmission optical device (“VTOD”) includes a first substrate structure including a first transparent electrode provided over a first substrate, and a second substrate structure including a second transparent electrode provided over a second substrate. The VTOD includes an electro-optic material provided between the substrates, wherein each transparent electrode is interposed between its respective substrate and the electro-optic material. The first and second substrate structures retain a curved shape such that the VTOD is characterized by at least a first curvature. At least one transparent electrode includes a transparent hybrid conductor having a multilayer or gradient structure. The transparent hybrid conductor includes a conductive polymer.

In accordance with another embodiment, a method of making a curved VTOD, the method includes providing a substantially planar VTOD in association with a shaping apparatus, the substantially planar VTOD and applying heat, force, or both heat and force to the VTOD to cause the first and second substrate precursor structures to permanently change shape in accordance with the shaping apparatus to form a curved VTOD having at least a first curvature. The substantially planar VTOD may include a first substrate precursor structure having a first transparent electrode material provided over a substantially planar first flexible substrate, and a second substrate precursor structure having a second transparent electrode material provided over a substantially planar second flexible substrate. A cell gap may be provided between the substrate precursor structures, wherein each transparent electrode is interposed between its respective flexible substrate and the cell gap. At least one transparent electrode material includes a transparent hybrid conductor having a multilayer or gradient compositional structure. The transparent hybrid conductor includes a conductive. Heat, force, or both heat and force may be applied to the substantially planar VTOD to cause the first and second substrate precursor structures to permanently change shape in accordance with the shaping apparatus to form a curved VTOD having at least a first curvature.

In accordance with another embodiment, a method of making a curved substrate structure includes providing a substrate precursor structure into a shaping apparatus, the substrate precursor structure including a transparent electrode material provided over a substantially planar flexible substrate. The transparent electrode material may include a transparent hybrid conductor having a multilayer or gradient compositional structure. The transparent hybrid conductor includes a conductive polymer. Heat, force, or both heat and force may be applied to the substrate precursor structure to cause the substrate precursor structure to permanently change shape in accordance with the shaping apparatus to form the curved substrate structure characterized by at least a first curvature,

One or more embodiments of the present disclosure may provide for curved optical devices and curved substrate structures that may have one or more of the following advantages: improved optical quality, improved electrical characteristics, improved uniformity across the device, and higher manufacturing yield.

### BRIEF DESCRIPTION OF DRAWINGS

FIG. 1 is a cross-sectional schematic of a non-limiting example of a curved VTOD according to some embodiments.

FIG. 2 is a cross-sectional schematic of a non-limiting example of a transparent hybrid conductor according to some embodiments.

FIGS. 3A-3D are cross-sectional schematics of non-limiting examples of a transparent hybrid conductor according to some embodiments.

FIG. 4 is a cross-sectional schematic of a non-limiting example of a transparent hybrid conductor according to some embodiments.

FIGS. 5A-5C are cross-sectional schematics of non-limiting examples of various curved VTODS according to some embodiments.

FIG. 5D is a perspective view of a non-limiting example of a curved VTOD according to some embodiment.

FIG. 6 is a perspective view of a non-limiting example of a multi-curved surface according to some embodiments.

FIG. 7 is a perspective view of a non-limiting example of a multi-curved surface and its projection onto a flat surface according to some embodiments.

FIG. 8A is a cross-sectional schematic of a non-limiting example of a substantially planar VTOD according to some embodiments.

FIG. 8B is a perspective view of a non-limiting example of a substantially planar VTOD according to some embodiments.

FIG. 8C is a perspective view of a non-limiting example of a substantially planar VTOD in association with a shaping apparatus according to some embodiments.

FIG. 9 is a perspective view of a non-limiting example of a curved VTOD that may be formed from a substantially planar VTOD according to some embodiments.

FIG. 10 is a schematic diagram of a non-limiting example of a shaping apparatus according to some embodiments.

FIG. 11 is a perspective view of a non-limiting example of a curved VTOD according to some embodiments.

FIG. 12 is a block diagrams outlining some non-limiting general steps for forming a curved VTOD according to some embodiments.

FIG. 13 is a block diagrams outlining some non-limiting general steps for forming a curved VTOD according to some embodiments.

FIG. 14 is a block diagrams outlining some non-limiting general steps for forming a curved VTOD according to some embodiments.

FIG. 15A is a schematic top view of a non-limiting example of a substrate precursor structure prior to stretching, according to some embodiments.

FIG. 15B is a schematic top view of the structure from FIG. 15A after stretching, according to some embodiments.

FIG. 16A is a schematic top view of a non-limiting example of a substrate precursor structure prior to stretching, according to some embodiments.

FIG. 16B is a schematic top view of the structure from FIG. 16A after stretching, according to some embodiments.

FIGS. 17A and 17B are photographs from two different angles of a non-limiting example of a substrate precursor structure stretched or thermoformed over a mold to form a curved substrate structure according to some embodiments.

FIG. 18 is a map of sheet resistances across the curved substrate structures, wherein the left half represents the data from Comparative A′ and the right half represents the data from Example 1′.

FIG. 19 is a histogram showing a distribution of counts for each sample within a particular sheet resistance range.

### DETAILED DESCRIPTION

### Curved VTOD

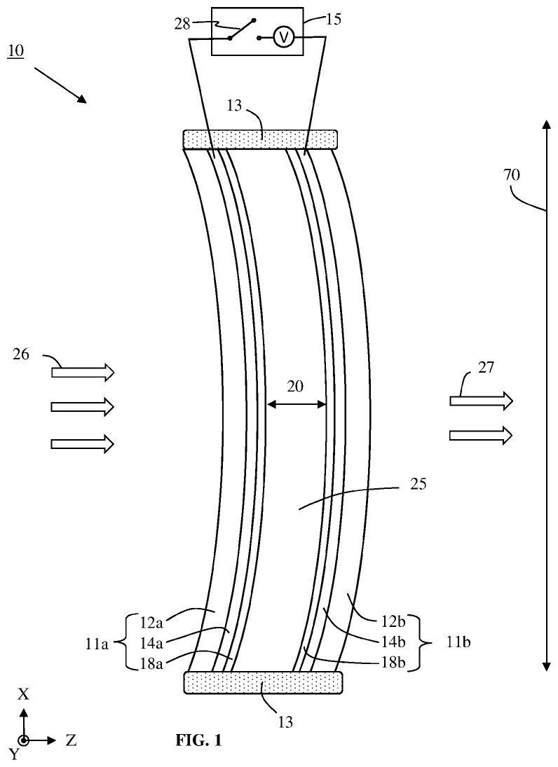

Curved light-adaptive eyewear, windows, mirrors, or the like may include one or more variable transmission optical devices (“VTODs”). FIG. 1 is a schematic cross-section of a non-limiting example of a curved VTOD according to some embodiments. For perspective, XYZ axes have been added to this and some other figures. Curved VTOD 10 can controllably act on incident light 26 so that transmitted light 27 has been modulated or altered in some way (brightness, hue, polarization, direction, or the like). Curved VTOD 10 may include a pair of curved substrate structures, for example, a first substrate structure 11a and a second substrate substructure 11b. In some cases, curvature may be measured relative to axis or direction 70. The first substrate structure may include a first substrate 12a and a first transparent electrode 14a provided over the first substrate. The second substrate structure may include a second substrate 12b and a second transparent electrode 14b provided over the second substrate. The first and second substrate structures may be the same or different with respect to layer composition, thickness, or some other physical or chemical property. As discussed elsewhere herein, a substrate may be formed a material capable of being manipulated to take on and retain a curved shape. In some embodiments, a substrate may include a polymeric material. The first and second substrates may be the same or different with respect to composition, thickness, or some other physical property. As discussed elsewhere herein, one or both transparent electrodes may include a transparent hybrid conductor that may have a multilayer or gradient compositional structure, and which includes an electrically conductive polymer. The first and second transparent conductors may be substantially the same or different with respect to composition, thickness, or some other physical or chemical property. For example, “substantially the same” in this context may correspond to thickness or composition metrics that are relatively within 30%, alternatively within 20% or 10%.

In some embodiments, an optional alignment layer 18a, 18b, may be provided over one or both the transparent conducting layers. As a non-limiting example, the alignment layer may include a polyimide material. In some embodiments, the alignment layer may be brushed as is known in the art to assist in orienting the electro-optic material, e.g., a liquid crystal “LC” host, near the surface. In some embodiments, both alignment layers of a cell are brushed. In some embodiments, a cell may include only one brushed alignment layer.

Although not shown, either or both substrate structures may include additional layers. For example, a generally non-electrically conductive passivation or insulating layer may optionally be provided over the transparent conducting layer. Such passivation layer may, for example, include a polymer, a non-conductive oxide, sol-gel, or a composite. If an alignment layer is present, the passivation layer may be interposed between the transparent conducting layer and the alignment layer. In some embodiments, a sublayer may optionally be provided between the substrate and the transparent conducting layer, for example, to increase adhesion between the transparent conducting layer and the substrate, improve optical outcoupling, increase scratch resistance, act as a solvent barrier, or for some other reason. In some embodiments, the opposite side of the substrate (without the transparent electrode) may also include one or more opposing layers. In some cases, the sublayer or the opposing layer(s) or both may include a hard coat layer to increase scratch resistance. However, in some embodiments, one or both substrate structures may exclude a hard coat, particularly hard coats that are made from low-flexibility materials such as inorganic oxides or the like.

In some embodiments, curved VTOD 10 includes electro-optic material 25, e.g., a liquid crystal guest-host mixture, provided between the cell's pair of substrate substructures 11a, 11b. The electro-optic material may be capable of, for example, changing from a state of higher light transmittance to a state of lower light transmittance in a desired wavelength region upon a change in an electric field applied across the electro-optic material. The electric field may be changed, for example, by changing the voltage applied between the curved VTOD's pair of transparent electrodes 14a, 14b. The space or distance between the substrate structures defines a cell gap 20. To aid in maintaining the separation, optional spacers (not shown), such as glass or plastic rods or beads, may be inserted or placed between the substrates. In some embodiments, the cell gap may be in a range of 3 to 5 microns, 5 to 7 microns, 7 to 10 microns, 10 to 12 microns, 12 to 15 microns, 15 to 20 microns, 20 to 30 microns, 30 to 35 microns, 35 to 40 microns, or 40 to 50 microns, or any combination of ranges thereof. The curved VTOD cell may be enclosed by sealing material 13 such as a UV-cured optical adhesive or other sealants known in the art.

The transparent electrodes 14a, 14b, may be electrically connected to a controller 15. Controller 15 may include one or more variable voltage supplies which are represented schematically by the encircled V. FIG. 1 shows the VTOD power circuit with its switch 28 open so that no voltage is applied. When switch 28 is closed, a variable voltage or electric field may be applied across liquid crystal guest-host mixture 25. In some embodiments, the voltage applied between the transparent conductive layers may be constant for a period of time with respect to polarity or amplitude. In some embodiments, the voltage profile may change or alternate at some frequency where, for a period of time, the polarity applied at first transparent electrode 14a is positive and the polarity applied at transparent electrode 14b is negative, and for another period of time, the polarities are reversed where the polarity applied at transparent electrode 14a is negative and the polarity applied at transparent electrode 14b is positive. This alternating polarity may take on any type of wave form (sinusoidal, square, triangular, sawtooth, or the like) and may sometimes have a frequency of less than about 200 Hz. In some cases when using alternating polarity, the frequency may be in a range of about 30 to about 200 Hz. In some embodiments, the voltage applied between the electrodes may be in a range of 0 to about 30 V.

In some embodiments, a light-adaptive window or eyewear system may include two or more stacked VTODs, e.g., as disclosed in International Application No. PCT/US22/44310, Titled “MULTI-COLOR VARIABLE TRANSMISSION OPTICAL DEVICE (Soto et al.) filed on Sep. 22, 2022, the entire contents of which are incorporated herein by reference for all purposes. In some embodiments, a light-adaptive window or eyewear system may include passive optical features such as lenses, polarizers, photochromic dyes, or the like, that do not generally respond to electronic control.

### Electro-Optic Material

An electro-optic material is one capable of changing its light absorption profile upon application of an electric field. Electro-optical systems include electrochromic and liquid crystal (LC) systems. In some embodiments, the electro-optic material includes a guest-host system having an LC host and optionally a dichroic (DC) dye dissolved, dispersed, or otherwise provided therein.

In some embodiments, guest-host system may be used to produce an electro-optical effect wherein the dichroism is adjusted within a voltage-controllable liquid crystal cell. In an isotropic host, the molecules are randomly oriented, and the effective absorption is a weighted average: α_{eff}=(2α⊥+αλ)/3. In an anisotropic LC host material, designed for polarization independent operation, the absorption can be increased to α_{eff}=(α⊥+αλ)/2 or decreased to α⊥, depending on the desired effect.

In some embodiments, a liquid crystal guest-host includes a mixture of a liquid crystal host and a dyestuff material. The dyestuff material may be characterized as having dichroic properties, and as described below, may include a single dye or a mixture of dyes to provide these properties. In some embodiments, the liquid crystal guest-host mixture may be formulated as a “narrow band mixture” (e.g., resulting in a spectral absorption band width having a Full Width at Half Max (FWHM) that is less than or equal to 175 nm) or as a “wide band mixture” (e.g., resulting in spectral absorption band width that is greater than 175 nm).

### LC Host

In some cases, the LC host may have a negative dielectric anisotropy (“negative LC”) or a positive dielectric anisotropy (“positive LC”). In some embodiments, the host includes a chiral nematic or cholesteric liquid crystal material (collectively “CLC”). The CLC can also be positive or negative, depending on the application. In some embodiments of the CLC, the liquid crystal material is cholesteric, or it includes a nematic liquid crystal in combination with a chiral dopant. A CLC material has a twisted or helical structure. The periodicity of the twist is referred to as its “pitch”. The orientation or order of the liquid crystal host may be changed upon application of an electric field, and in combination with the dyestuff material, may be used to control or partially control the optical properties of the cell. In some embodiments, the CLC may be further characterized by its chirality, i.e., right-handed chirality or left-handed chirality.

A wide variety of LC, including CLC, materials are available and have potential utility in various embodiments of the present disclosure. In some embodiments, the LC host may be a nematic LC (zero chiral) or a ferroelectric or smectic, and may have positive or negative dielectric anisotropy. It should be noted that a non-zero d/p can be achieved by using properly rubbed surfaces as known in the art.

### Dyestuff Material

When dichroic properties are desired, the dyestuff material generally includes at least one dichroic (DC) dye or mixture of DC dyes. In some cases, the dyestuff material may optionally further include a photochromic (PC) dye or a photochromic-dichroic (PCDC) dye whose light absorbance may be activated by exposure to UV light such as sunlight. In some embodiments, the dyestuff material may further include a small amount of a conventional absorbing dye, e.g., to provide the device with a desired overall hue in the clear state.

### DC dyes

Dichroic (DC) dyes typically have an elongated molecular shape and exhibit anisotropic absorption. Commonly, the absorption is higher along the long axis of the molecule and such dyes may be referred to as “positive dyes” or dyes exhibiting positive dichroism. Positive DC dyes are generally used herein. However, in some cases, negative DC dyes that exhibit negative dichroism may be used instead. In some embodiments, a DC dye (as measured in a LC host) may have a dichroic ratio of at least 5.0, alternatively at least 6, 7, 8, 9, 10, 11, 12, 13, 14, 15, 16, 17, 18, 19 or 20.

The level of visible light absorption by the DC dye may be a function of the dye type and the LC host. The apparent absorption of visible light may also be a function of voltage. The orientation or long-range order of the LC may be a function of electric field or voltage across the cell thickness. A DC dye exhibits some alignment with the LC host so that application of a voltage may be used to alter the apparent darkness (absorbance) or transparency (opaque-ness) of the cell.

In some embodiments, a DC dye may include a small molecule type of material. In some embodiments, a DC dye may include an oligomeric or polymeric material. The chemical moiety responsible for light absorption may, for example, be a pendant group on a main chain. Multiple DC dyes may optionally be used, for example, to tune the light absorption envelope or to improve overall cell performance with respect to lifetime or some other property. DC dyes may include functional groups that may improve solubility, miscibility with or bonding to the LC host. Some non-limiting examples of DC dyes may include azo dyes, for example, azo dyes having 2 to 10 azo groups, or alternatively, 2 to 6 azo groups. Other DC dyes are known in the art, such as anthraquinone and perylene dyes.

Molecules with dichroic properties may, for example, include those described in “Dyes as guests in ordered systems: current understanding and future directions” By Mark T. Sims (Pages 2363-2374) in Liquid Crystals, Volume 43, 2016—Issue 13-15.

Although VTOD devices have been described with respect to certain LC cells, devices and methods of the present disclosure may also be applied to other types of variable transmission optical devices, e.g., electrochromic devices that may optionally include inorganic materials. In some embodiments, a VTOD device may not only alter transmission of light (hue, polarization, direction), but may alter reflectivity of a light adjusting device.

### Substrate

Referring again to FIG. 1, in some embodiments, the VTOD substrate 12a, 12b may be independently selected and may include a plastic, a glass, a ceramic, or some other material. In some embodiments, at least one substrate or alternatively both substrates include a material that can be manipulated from a first shape to take on and retain a second shape, for example, a curved shape. By retaining a shape, it is not meant that the substrate or substrate structure is inflexible, but rather, that the new shape is generally maintained when at rest in the absence of external forces. In some cases, such a substrate material may include a polymeric material. In some embodiments, the substrate may include a plastic material, including but not limited to, a thermoplastic material. In some cases, a substrate material may be a thermosetting polymer, for example, a polymer initially having high manipulability to form a new shape and which may be later “cured” to generally retain that shape. Such curing may include heat, UV radiation, chemical treatment, or some other stimulus. As some non-limiting examples, a substrate may include (alone or in combination with other materials) a polycarbonate (PC), a polycarbonate and copolymer blend, a polyethersulfone (PES), a polyethylene terephthalate (PET), cellulose triacetate (TAC), a polyamide, p-nitrophenylbutyrate (PNB), a polyetheretherketone (PEEK), a polyethylenenapthalate (PEN), a polyetherimide (PEI), polyarylate (PAR), a polyvinyl acetate, a cyclic olefin polymer (COP) a polyester, a polyurethanes, a polysilicone, a polyacrylate, a polypropylene, a polyethylene, a polystyrene, a polyvinyl chlorides, a polylactic acid, an ABS polymer, or some other polymeric material having the desired properties. A substrate may include a composite of materials, for example, a polymeric material in combination with a glass, ceramic, or other inorganic additives. In some embodiments a substrate may have higher than 45% transmission to visible radiation having a wavelength between 400 nm and 700 nm, alternatively, higher than 50%, 60%, 70%, 80%, 90%, or 95% transmission. In some embodiments, the substrate may have high optical clarity (low haze) so that a person may clearly see through the VTOD. In some embodiments, the support may optionally have some color or tint. A substrate may include multiple materials or have a multi-layer structure. In some embodiments, the thickness of a substrate may be in a range of 10-20 μm, 20-30 μm, 30-40 μm, 40-50 μm, 50-75 μm, 75-100 μm, 100-150 μm, 150-200 μm, 200-250 μm, 250-300 μm, 300-350 μm, 350-400 μm, 400-450 μm, 450-500 μm, 500-600 μm, 600-800 μm, 800-1000 μm, or greater than 1 mm or any combination of ranges thereof.

### Transparent Electrode

“Visible light” generally refers to a wavelength range of about 400 nm to about 700 nm. By “transparent” electrode or conducting layer, it is meant that the conducting layer allows an overall transmittance of at least 45% of incident visible light. A transparent electrode may absorb or reflect a portion of visible light and still be useful.

In some embodiments, at least one substrate structure may include a transparent hybrid conductor that may have a multilayer or gradient compositional structure, and includes an electrically conductive polymer. FIG. 2 is a cross-sectional schematic of a non-limiting example of a transparent hybrid conductor according to some embodiments. Substrate structure 211 may include a transparent substrate 212 and a transparent electrode, i.e., a transparent hybrid conductor 214 disposed over the substrate. For clarity, the curvature is not illustrated. The hybrid conductor may include a multilayer or gradient compositional structure. For example, hybrid conductor 214 may include a lower portion 231 adjacent the substrate 212 and an upper portion 233 overlaying the lower portion and having a different composition. Although not shown, the upper portion 233 may be adjacent the electro-optic material, optionally with one or more intervening layers such as an alignment layer or passivation layer as described with respect to FIG. 1. In some embodiments, the two portions may be distinct conductive layers. In some embodiments, the two portions may represent sections of a compositional gradient such that the lower portion of the hybrid conductor (e.g., the lower 50%, 25% or 10% as measured from the bottom of the hybrid conductor) has a different composition or proportion of materials relative to the upper portion (e.g., the upper 50%, 25%, or 10% as measured from the top of the hybrid conductor).

Whether a gradient, distinct layers, or some combination, a “different composition” in this context means that a weight percent of at least one electrically conductive agent in the upper portion (or layer) is different than the weight percent of that same electrically conductive agent in the lower portion (or layer). In general, a different composition is one where the ratio of the upper and lower portion weight percents of at least one electrically conductive agent is outside a range of 0.5 to 2.0. In some cases, an electrically conductive agent used in the lower portion may be entirely absent from the upper portion which uses a different type of electrically conductive agent, or vice versa.

The transparent hybrid conductor includes at least one electrically conductive agent. In some preferred embodiments, the transparent hybrid conductor includes at least two different electrically conductive agents. Electrically conductive agents are materials that conduct electrical charge and may, in some cases, have a conductivity of at least 0.1 S/cm. An electrically conductive agent may in some cases be an intrinsically conductive polymer including, but not limited to, a PEDOT such as PEDOT: PSS, a poly(pyrrole), a polyaniline, a polyphenylene, or a poly(acetylene). An electrically conductive agent may in some cases be a metal, including but not limited to, silver, copper, aluminum, titanium, iron, zinc, nickel, tungsten, cobalt, a transition metal, or an alloy. An electrically conductive agent may in some cases be a metal oxide such as a transparent conductive oxide (TCO), including but not limited to indium-doped tin oxide (ITO), aluminum-doped zinc oxide (AZO), and fluorine-doped tin oxide (FTO). An electrically conductive agent may in some cases include a carbon-based material such as carbon nanotubes (CNTs) or graphene.

In some cases, the electrically conductive agent may be provided as a discontinuous layer or continuous layer (if sufficiently transparent). In some cases, the electrically conductive agent may be provided as particles dispersed in a transparent matrix. There is no particular limitation on the shape of such particles, which may be spheroidal, oblong, cubic, flakes, sheets, nanowires (NWs), nanotubes, or any combination thereof, or some other shape.

The hybrid conductor includes a conductive polymer having at least one electrically conductive agent. In some embodiments, the conductive polymer includes an intrinsically conductive polymer as described above (e.g., a PEDOT such as PEDOT: PSS, a poly(pyrrole), a polyaniline, a polyphenylene, or a poly(acetylene) or a mixture thereof). In some embodiments, the conductive polymer may include a nonconductive polymer and at least one electrically conductive agent other than an intrinsically conductive polymer, such as metal particles, metal NWs, TCO particles, CNTs or the like. Such conductive agents may be provided in sufficient concentration that they create an interconnected network of conductive particles in the nonconductive polymer matrix. In some embodiments, the conductive polymer may include both an intrinsically conductive polymer and another electrically conductive agent dispersed therein (homogeneously or heterogeneously), e.g., metal particles, metal NWs, TCO particles, CNTs or the like.

In some embodiment, the conductive polymer is pliable and can be stretched at least 40%, or alternatively at least 50%, 60%, 70%, 80%, 90% in at least one direction and still maintain its electrical functionality in the hybrid conductor. For example, its average resistance may increase by less than 10×, or alternatively by less than 5×, or 2× upon such a stretch.

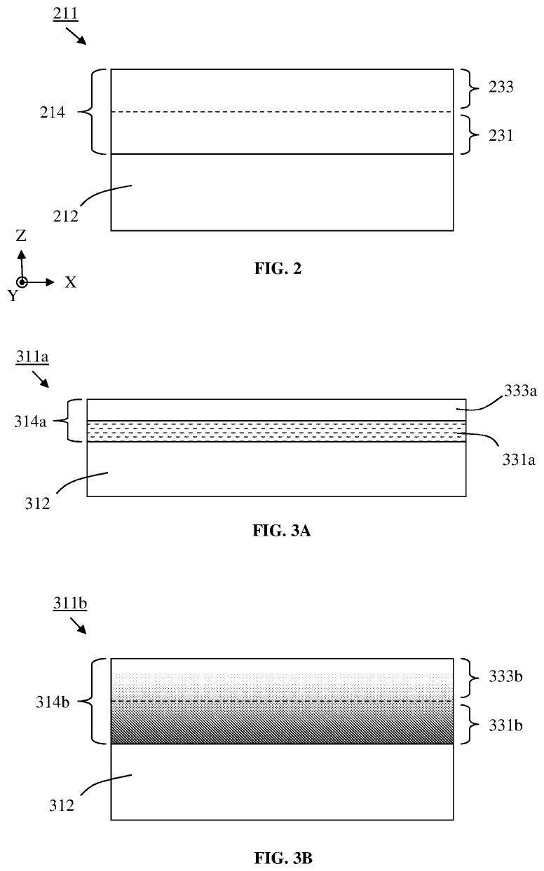

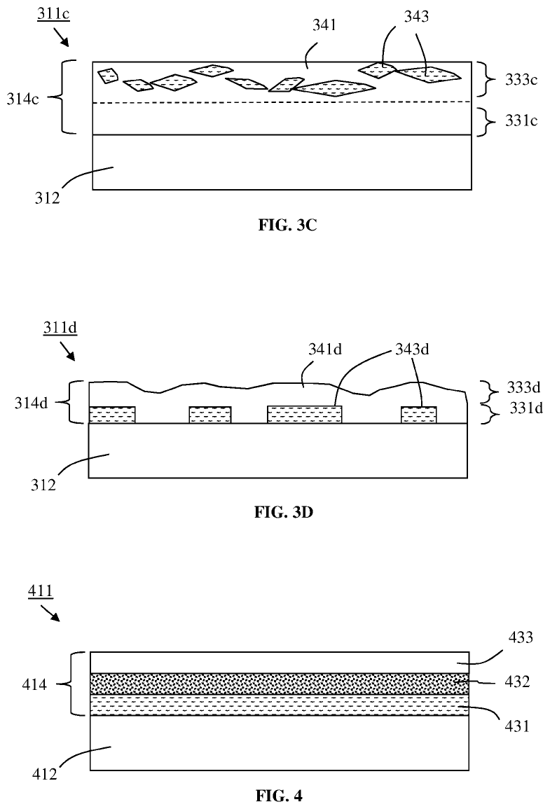

FIGS. 3A-3E and 4 are cross-sectional views of some non-limiting embodiments of transparent hybrid conductors according to some embodiments. As with FIG. 2, for clarity, curvature is not illustrated.

In FIG. 3A, substrate structure 311a includes transparent hybrid conductor 314a provided over substrate 312. In this embodiment, hybrid conductor 314a has a multilayer structure and includes a first (or lower) conductive layer 331a and a second (or upper) conductive layer 333a. The first and second conductive layers have different compositions. They are shown as discrete layers, but in some cases, there can be some mixing at the interface. Note that a multilayer structure includes at least 2 distinct layers in cross section in at least some portions of the substrate structure. A multilayer structure may have 3 or even more layers in some embodiments.

In some embodiments, both the first and second conductive layers are independently selected conductive polymers (first and second conductive polymer layers). In some cases, at least one conductive polymer layer includes a supplemental conductor material. A “supplemental conductor” material is a conductive material selected from electrically conductive agents other than intrinsically conductive polymers. In some cases, at least one conductive polymer layer includes an intrinsically conductive polymer, which may optionally further include a supplemental conductor.

In some embodiments, the second conductive layer 333a is a conductive polymer and the first conductive layer 331a is not a conductive polymer. In such embodiments, the first conductive layer includes a supplemental conductor such as TCO (solid layer, discontinuous layer, or particles), a thin metal layer, metal particles, metal nanowires, CNTs, or graphene. While there may be a relatively small amount of polymeric binder, the first conductive layer of this embodiment may have low stretchability and not possess the pliability of a conductive polymer. In some cases, the second conductive layer (a conductive polymer) includes an intrinsically conductive polymer and may optionally further include a supplemental conductor.

In some embodiments, the first conductive layer 331a is a conductive polymer and the second conductive layer 333a is not a conductive polymer. In such embodiments, the second conductive layer includes a supplemental conductor such as TCO (solid layer, discontinuous layer, or particles), a thin metal layer, metal particles, metal nanowires, CNTs, or graphene. While there may be a relatively small amount of polymeric binder, the second conductive layer of this embodiment may have low stretchability and not possess the pliability of a conductive polymer. In some cases, the first conductive layer (a conductive polymer) includes an intrinsically conductive polymer material and may optionally further include a supplemental conductor.

FIG. 3B shows another substrate structure 311b having a transparent hybrid conductor 314b disposed over substrate 312. Hybrid conductor 314b may include a conductive polymer that has a gradient compositional structure. For example, upper portion 333b may include less of a particular electrically conductive agent than a lower portion 331b. The gradient may be smooth (as shown), more localized, or have a compositional midpoint closer that is closer or further from the substrate than shown in FIG. 3B.

FIG. 3C shows another substrate structure 311c having a transparent hybrid conductor 314c disposed over substrate 312. Transparent hybrid conductor 314c may be characterized as a bilayer or gradient structure, where a lower portion 331c includes a conductive polymer and upper portion 333c includes a conductive polymer material 341 in addition to supplemental conductor 343, e.g., in the form of particles, nanowires, or nanotubes. There is not necessarily a defined boundary between the upper and lower portions, but in some cases, they may be distinct layers. In another embodiment (not shown), the supplemental conductor could instead be in the lower portion.

FIG. 3D shows another substrate structure 311d having a transparent hybrid conductor 314d disposed over substrate 312. The transparent hybrid conductor may have a multilayer structure characterized by a conductive polymer 341d provided over and between segments of a supplemental conductor 343d disposed on portions of the substrate 312. In cross section, the upper portion 333d of the transparent hybrid conductor 314d (that mostly does not include the supplemental conductor) has a different composition than the lower portion 331d (that does include the supplemental conductor). Substrate structure 311d illustrates an embodiment where the transparent hybrid conductor is not necessarily flat, but in some other embodiments (not shown), the conductive polymer 341d could be planarizing and generally have a flat surface. In some embodiments, the supplemental conductor 343b may be sections of a TCO that broke into segments during stretching. In some embodiments, supplemental conductor 343d may represent metal nanowires or CNTs. In some embodiments, conductive polymer 341d may include an intrinsically conductive polymer, and may optionally further include another supplemental conductor material that could be the same or different than the material used in 343d.

FIG. 4 shows substrate structure 411 having a transparent hybrid conductor 414 disposed over substrate 412. Transparent hybrid conductor 414 may have a multilayer structure having a lower conductive layer 431, an upper conductive layer 433, and an intermediate conductive layer 432 interposed between the upper and lower conductive layers. At least one of the upper, lower, or intermediate conductive layers is a conductive polymer, alternatively at least two, or even all three layers may be conductive polymers. Any of the options for conductive layers discussed elsewhere herein can be applied to the intermediate layer.

In some embodiments, the hybrid conductor may include materials other than electrically conductive materials, e.g., binders, elastomers, coating aids, adhesives, surfactants, or even a small amount of solvent such as water or an organic solvent.

In some embodiments one substrate structure may be the same as or different than the other substrate structure with respect to materials, properties, layer structure, or the like. In some embodiments, both substrate structures may include a transparent hybrid conductor. In some cases, one substrate includes a transparent hybrid conductor, and the other substrate structure uses a non-hybrid conductive polymer as its transparent electrode, or alternatively, does not use a conductive polymer at all, e.g., uses a low pliability layer of TCO, metal nanowires, graphene, or carbon nanotubes.

### Curvature

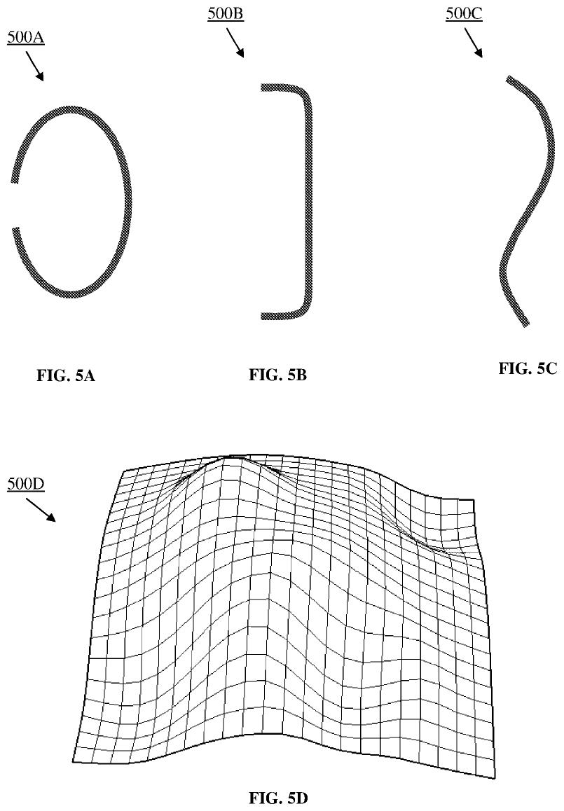

According to some embodiments, the curved VTOD may have at least one curvature along a first direction (a first curvature). Referring again to FIG. 1, curved VTOD may have a first curvature with respect to axis 70. A curvature may be measured from a surface of one of the substrate structures. In some cases, the curvature of each substrate structure may generally match, but in some cases, there may be some difference so long as the cell gap does not vary outside a desired range. There is no particular limitation on the curvature shape. In some cases, a curved VTOD may include just one curvature. In some embodiments, a curved VTOD may have alternate or more complex curvatures than shown in FIG. 1, even in just one dimension. FIGS. 5A-5C are cross-sectional schematics of non-limiting examples of various curved VTODs according to some embodiments. In FIG. 5A, curved VTOD 500A in cross-section may form a nearly full oval. In FIG. 5B, curved VTOD 500B may in cross section have a substantially flat portion and significant curves at the ends. In FIG. 5C, curved VTOD 500C may in cross-section have an undulating or corrugated type of curvature. Numerous other curvatures may be made. FIG. 5D is a perspective view of curved VTOD 500D having a complex, non-symmetrical curvature. The grid lines are added to the figure to help illustrate the topography.

In some embodiments, a curved VTOD may have a multicurved surface. As used herein, a “multicurved surface” mean a non-planar shape having compound curves, also referred to as non-developable shapes, which may include but are not limited to a spherical surface, an aspherical surface, and a toroidal surface, where the curvature of two orthogonal axes (horizontal and vertical one) are different, which may be for example a toroidal shape, an oblate spheroid, oblate ellipsoid, prolate spheroid, prolate ellipsoid, or where the surface's principle curvature along two orthogonal planes are opposite, for example a saddle shape or surface, such as a horse or monkey saddle. Other examples of multicurved surfaces include, but are not limited to, an elliptic hyperboloid, a hyperbolic paraboloid, and a spherocylindrical surface, where the multicurved surface may have constant or varying radii of curvature. The multicurved surface may also include segments or portions of such surfaces, or be comprised of a combination of such curves and surfaces. In some embodiments, the multicurved surface may have radii of curvature along two orthogonal axes. In various embodiments, the multicurved surface may be symmetrical or asymmetrical.

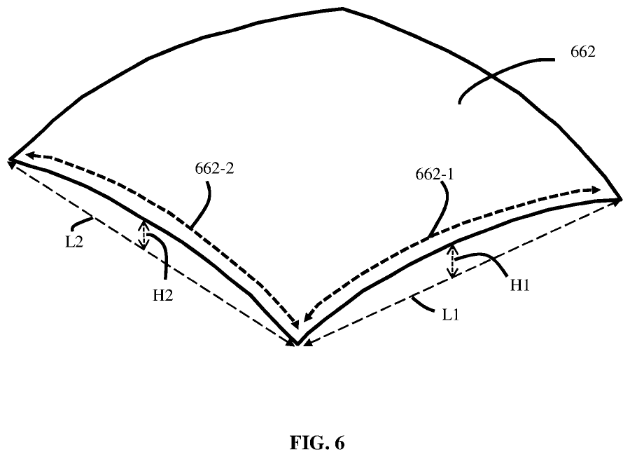

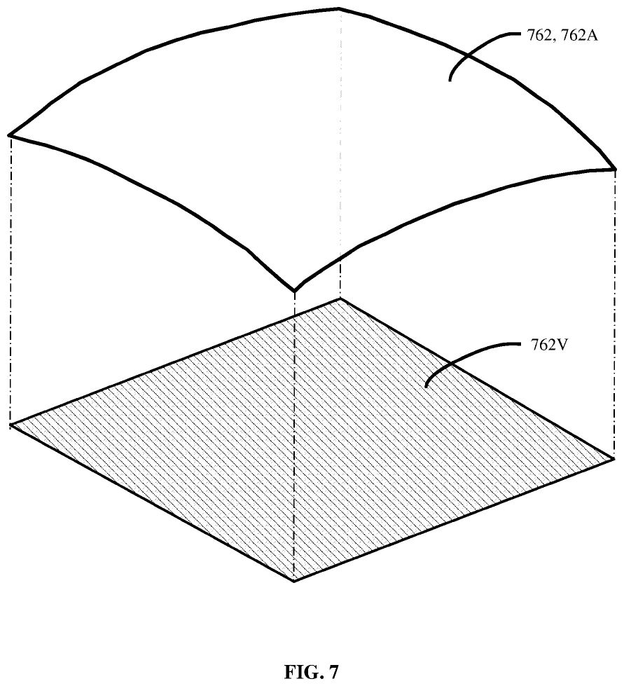

There are many ways to characterize a singly-or multi-curved surface. Referring to FIG. 6, a curved surface 662 may be characterized as having a first curvature 662-1 having a first height H1 and a first length L1 measured along a first direction, wherein a first curvature ratio C1=H1/L1. In the case where curved surface 662 is a multicurved surface (as shown here), the multicurved surface may be further characterized as having a second curvature 662-2 having a second height H2 and second length L2 measured along a second direction different from the first direction, wherein a second curvature ratio C2=H2/L2. In some embodiments the second direction may be orthogonal to the first direction. The first curvature may be the same as or different than the second curvature. In some embodiments such as shown in FIG. 6, L1 and L2 may correspond to the entire point-to-point lengths corresponding to the curved VTOD. In some embodiments, L1 and L2 may instead correspond to a portion of the multicurved surface defining the lengths between inflection points in the curves. In some embodiments, one or both C1 and C2 may be greater than zero, and at least one or optionally both of C1 and C2 is less than 10, 5, 3, 2, 1, 0.9, 0.8, 0.7, 0.6, 0.5, 0.4. 0.3, 0.2, 0.1, 0.05, 0.02, 0.01, 0.005, 0.002, or 0.001. Alternatively, the curvature at any point can be described in terms of a local “diopter” defined as D=0.5/R where R is the radius of curvature in any one direction at the point measured in meters. In some cases, the D in any one direction can be less than or equal to 20, 15, 10, 8, 7, 6, 5, 4, 3, 2, 1, 0.5, or 0.2.

In some embodiments, the multicurved surface 662 may be characterized by a first curvature 662-1 curved to a first value of greater than 0 diopter, and a second curvature 662-2 along a different axis than the first curvature and curved to a second value of greater than 0 diopter. In some embodiments, the second curvature may be orthogonal to the first curvature. One or both of the first value and the second value may be less than 20, 15, 10, 8, 6, 5, 4, 3, 2, or 1.

Referring to FIG. 7, in some embodiments, the surface area 762A of a multicurved surface 762 may be greater than the virtual area 762V defined by a projection of the multicurved surface onto a virtual flat surface. In some embodiments, relative to virtual area 762V, surface area 762A may be greater by an amount in a range of 0.1-0.2%, 0.2-0.3%, 0.3-0.4%, 0.4-0.5%, 0.5-0.6%, 0.6-0.7%, 0.7-0.8%, 0.8-1.0%, 1.0-1.2%, 1.2-1.4%, 1.4-1.6%, 1.6-1.8%, 1.8-2.0%, 2.0-2.5%, 2.5-3.0%, 3.0-3.5%, 3.5-4.0%, 4.0-4.5%, 4.5-5%, 5-6%, 6-7%, 7-8%, 8-9%, 9-10%, 10-11%, 11-12%, 12-13%, 13-14%, 14-15%, 15-20%, 20-30%, 30-40%, 40-50%, 50-75%, 75-100%, 100-125%, 125-150%, 150%-200%, 200-300%, 300-400%, or any combination thereof.

### Methods for Making Curved VTOD

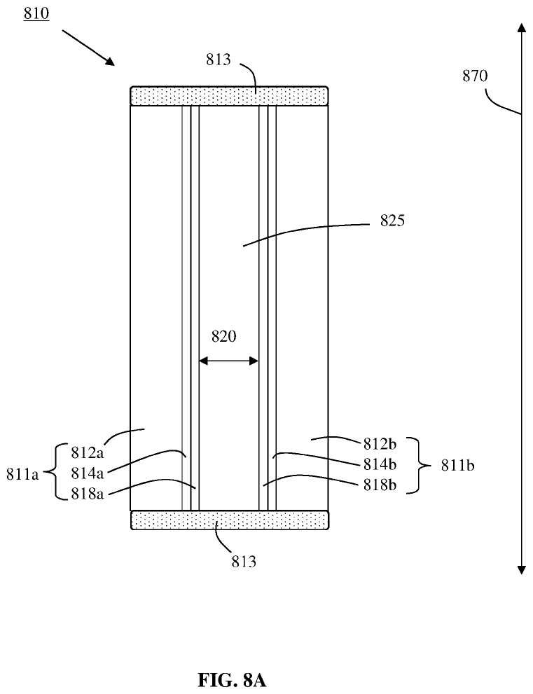

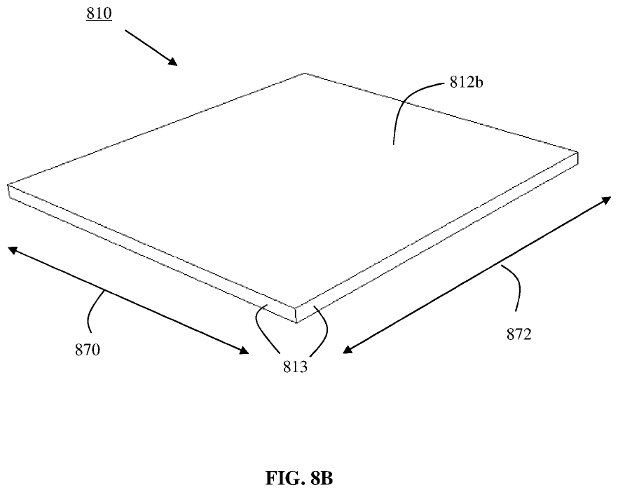

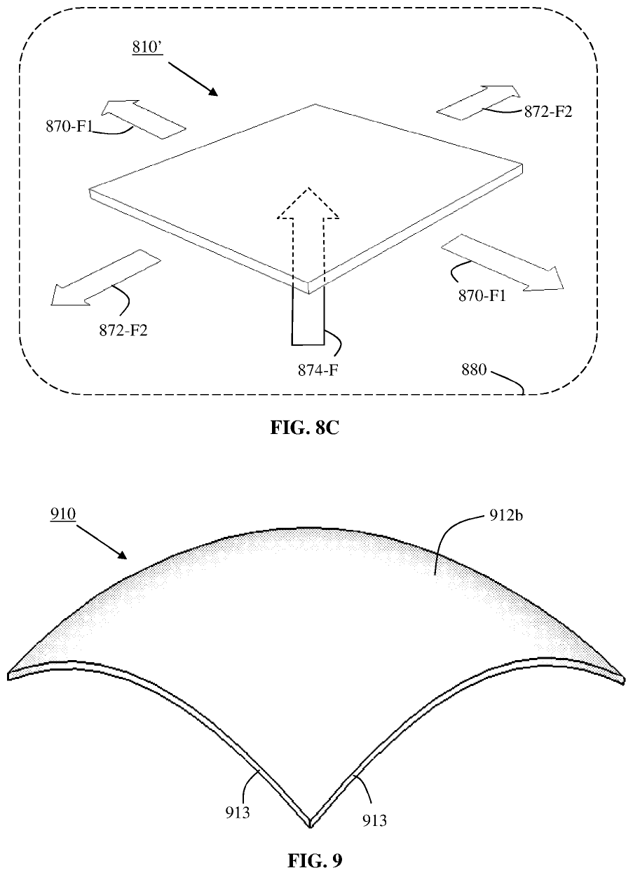

In some embodiments, forming a curved VTOD may start with a substantially planar VTOD, which may be considered a curved VTOD precursor. FIG. 8A is a cross-sectional schematic and FIG. 8B is a perspective view of a non-limiting example of a substantially planar VTOD according to some embodiments. Except for the substantially planar nature, the properties, materials, and layer structures discussed with respect to a curved VTOD may generally be employed in the substantially planar VTOD. By “substantially planar” it is meant that the device or substrate has, in the absence of applied forces, less than the desired curvature of the intended curved VTOD. In some cases, a substantially planar component may naturally rest flat against a flat surface, but it may have some curl or curvature. In some embodiments, a substantially planar component has less than 75% of a desired curvature for a curved VTOD in at least one dimension, alternatively, less than 50%, 40%, 30%, 20%, 15%, 10%, or 5%. Substantially planar VTOD 810 may include a first substate precursor structure 811a which may include a first transparent electrode material 814a provided over a substantially planar first flexible substrate 812a. Substantially planar VTOD 810 may further include a second substrate precursor structure 811b which may include a second transparent electrode material 814b provided over a substantially planar second flexible substrate 812b. The first and second substrates may extend in a plane approximately parallel to a plane defined by a first direction 870 and a second direction 872 (FIG. 8B). One or both transparent electrode materials may include a hybrid conductor as discussed elsewhere herein. Similarly, the materials and properties of the substrates may be as described elsewhere herein. In some embodiments, an optional alignment layer 818a, 818b, may be provided over one or both the transparent conducting layers.

Although a curved VTOD may be the desired product, it is often difficult to uniformly apply layers such as the transparent electrode over a non-planar substrate. Many coating and deposition methods are better suited for deposition onto relatively flat targets. Thus, in some embodiments, it may be useful to start with substantially planar substrates on which additional layers are coated.

Referring again to FIG. 8A, the space between the substrate structures defines a cell gap 820. To aid in maintaining the separation, optional spacers (not shown), such as glass or plastic rods or beads, may be provided between the substrates. In some embodiments, the space may include an electro-optic material 825, e.g., a liquid crystal guest-host mixture. However, in making the curved VTOD, the substantially planar VTOD may in some cases not include the electro-optic material until after the curvature has been formed. That is, in some cases, the electro-optic material may be provided later. The substantially planar VTOD may be enclosed, or partially enclosed, by sealing material 813 such as a UV-cured optical adhesive or other sealants known in the art. In some cases, the substantially planar VTOD may only be partially enclosed so that electro-optic material may be filled later. In some embodiments, the space may be filled with a temporary fluid that is later replaced by the electro-optic material after forming the curvature.

In some embodiments, the substantially planar VTOD may be provided in association with a shaping apparatus that may act on the substantially planar VTOD to form a curved VTOD. FIG. 8C is a perspective view like that of FIG. 8B, but substantially planar VTOD 810 has been placed in association with (for example, placed into) a shaping apparatus 880. Shaping apparatus 880 may act on the substantially planar VTOD, e.g., by applying heat, one or more forces, or both. In some embodiments, shaping apparatus 880 may be at an elevated temperature so that the VTOD substrates are relatively soft and formable (if they are not already). In some cases, a first force (870-F1) may be applied along a first direction or axis 870 and a second force may (872-F2) be applied along a second direction or axis 872. Concurrently, an orthogonal force 874-F that may be generally orthogonal to the plane of the VTOD substrates may also be applied. These forces form an intermediate VTOD 810′ that starts to change shape. Note that the operation of the shaping apparatus may include one or more actions that are applied manually by a person. Eventually, the VTOD reaches the desired curvatures (in this case, a multicurved surface) in accordance with the shaping apparatus. In some embodiments, upon cooling (if heated), the curved VTOD is formed. FIG. 9 is a perspective view of a non-limiting example of a curved VTOD 910 that may be formed from substantially planar VTOD 810. For clarity only the second substrate 912b and sealing material 913 at the edge are labelled. Curved VTOD 910 may include any of the properties, materials, or layer structure as described elsewhere herein.

The overall surface area of curved VTOD 910 may be higher than that of substantially planar VTOD 810. In some embodiments, the surface area of a curved VTOD may be at least 5% higher than the substantially planar VTOD (or corresponding substrate precursor structures) from which it was made, alternatively, at least 10%, 20%, 30%, 40%, 50%, 60%, 80%, 100%, 125%, 150%, 175%, 200%, 250%, 300%, or 400% higher, or even more. In some embodiments, these changes in surface area may correspond to the surface area of a transparent electrode layer after curvature relative to the surface area of the transparent electrode material before curvature. In some cases, the thickness of at least a portion of one or both substrates of curved VTOD 910 may be lower (thinner) than that of substantially planar VTOD 810.

Forces may include stretching, pulling, compressing, pulling, or any force that may cause at least some increase or other change in surface area. As mentioned, heat may be applied in some cases, e.g., so that the temperature of one or both substrates is within 20° C. of the substrate's glass transition temperature (Tg) or higher, alternatively within 10° C. of the substrate Tg or higher, alternatively at least at the substrate Tg, alternatively at least 10° C. higher than the substrate Tg. Characterized another way, the temperature Ts of a substrate may follow the relationship: Ts>(Tg−20° C.), alternatively Ts≥(Tg−10° C.), alternatively Ts≥(Tg), or alternatively Ts≥(Tg+10° C.). The temperature should not exceed a point where the substrate becomes so fluid that it is no longer handleable by the shaping apparatus, or the overlying layers are no longer adhered. The forces may be applied for a period of time which may be a function of temperature and the force. In some cases, the forces and/or temperature applied may change during the shaping.

Heat may be applied in a variety of ways. In some embodiments, the substrate(s) may be warmed in an oven and then removed to the shaping apparatus. In some cases, the shaping apparatus environment or components may be heated. Methods of applying heat may include the use of heating elements, IR lamps, flashlamps, hot air supply, microwaves, or any other suitable heating technology.

In some embodiments, the shaping apparatus may include a physical mold against which the VTOD is compressed or otherwise applied, and the curved VTOD product is then released. In some embodiments, a mold may include a low adhesion release layer or coating to aid in separating the curved VTOD. In some cases, the shaping apparatus may include a carrier that may act as a mold against which the VTOD is compressed, but wherein the curved VTOD remains laminated to the carrier as part of the final product. For example, a VTOD may be laminated over an eyewear lens, a jet cockpit, a visor, a curved window or mirror, or the like. In some cases, a shaping apparatus may utilize a blow mold principle rather than, or in addition to, a physical mold.

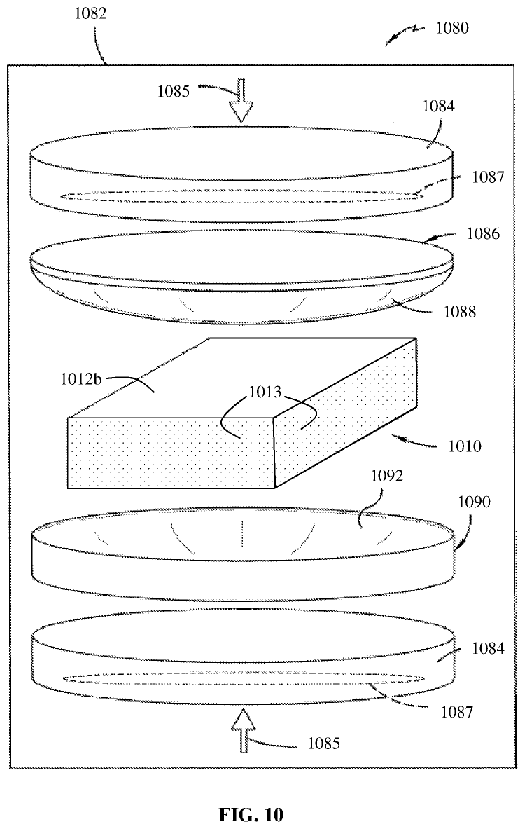

In some cases, the shaping apparatus may employ thermoforming, for example, as described in U.S. Pat. Nos. 7,102,602, 7,705,959, and 7,811,482, the contents of which are incorporated by reference herein for all purposes. FIG. 10 is a schematic diagram of a non-limiting example of a shaping apparatus according to some embodiments. In some embodiments, a shaping apparatus 1080, may be employed to manufacture a curved VTOD or VTOD component, such as a curved substrate structure. The shaping apparatus 1080 may include a heat chamber 1082 which is able to raise and lower temperatures as needed during the manufacturing process. Contained within the heat chamber 1082 are a pair of opposed platens 1084 which are adaptable to receive pressure forces 1085 so as to allow for closure and opening of the platens 1084 in a conventional manner. Application of the pressure force 1085 may be controlled and coordinated with the application of heat in a manner that will be described below. In some cases, heating elements 1087 may be carried by the platens 1084 or even by the molds 1086, 1090. Alternatively or in addition, the substantially planar VTOD 1010 may be heated in a separate chamber and then transferred in a timely manner to the molds for forming.

In FIG. 10, while only substrate 1012b and sealing material 1013 are labeled for clarity, substantially planar VTOD 1010 may optionally be analogous to that described with respect to planar VTOD 810 and may include any of the various properties, materials, or layer structures as described elsewhere herein. Attached to the upper platen may be a half-mold 1086 which provides a mold face 1088. Likewise, attached to the lower platen 1084 may be a second half-mold 1090 which has a mold face 1092.

The substantially planar VTOD 1010 may inserted between the two mold faces 1088 and 1092, wherein each mold face possesses the desired final shape for each side of the optical device. The faces may be mates for one another, such that by themselves, one fits tightly inside the other with minimal residual space therebetween. Or one mold face may have a slightly different curvature than the other mold face depending upon the end use of the device. The mold faces 1088, 1092 remain comparatively rigid and undeformable throughout the fabrication process. The VTOD 1010 is brought to an elevated temperature by the chamber 1082, and a compressive force 1085 is applied to the VTOD 1010 by the platens 1084, wherein the force is essentially perpendicular to the initially flat VTOD. The temperatures and the compressive forces are generally linked in forming the end product. The combination of temperature and force should be large enough so that the substrates conform to the mold faces 1088, 1092, and so that they permanently retain the mold face shape after the temperature is lowered and the force removed. In other words, in some embodiments, no other restraining forces are required to maintain the curved shape of the optical device. However, the temperature and force should generally not be great enough to bring the inner substrate surfaces closer to one another than the size of the spacers (if present) or intended cell gap. It has been found that if the temperature and/or force are too large, the substrates become too close to each other and the substrates soften too much adjacent the individual spacers (if used), thus dimpling the substrate. Accordingly, the temperature/force combination and their rates of application must be large enough to imbue the initially planar VTOD 1010 with the desired curved shape, but not large enough to cause the cell gap to be out of its intended specification. At a higher processing temperature, a smaller compression force may be required. Conversely, at a lower processing temperature, a greater compression force may be needed. It will be appreciated that the temperature of the process should not exceed the melting temperatures of the substrates. In the absence of additional curing steps (such as by radiation or the like), the operating temperature of the curved VTOD produced in this manner is generally below the thermal forming temperature. The compressive force and elevated temperature are applied to VTOD 1010 for a sufficient time such that the VTOD retains the shape imbued by the molds after the force is removed and the temperature lowered. Moreover, the shape generally remains without the application 21 of any other force.

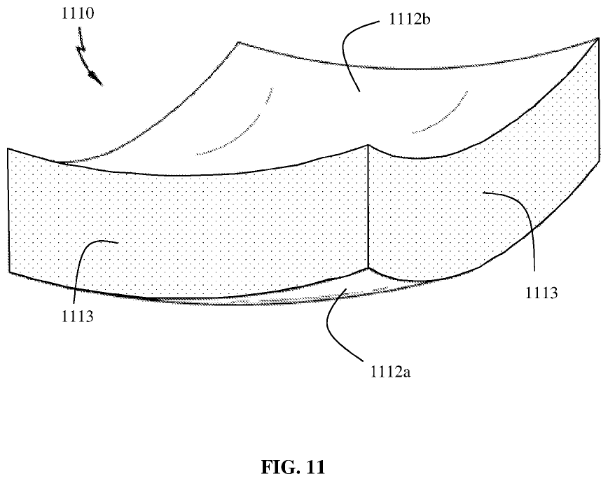

FIG. 11 is a perspective view of a non-limiting example of a curved VTOD according to some embodiments. Curved VTOD 1110 may be formed from the shaping apparatus acting on VTOD 1010 as shown in FIG. 10. In FIG. 11, while only the substrates 1112a, 1112b and sealing material 1113 are labeled for clarity, curved VTOD 1110 may include any of the various properties, materials, or layer structure options as described with respect to FIG. 1 and elsewhere herein. Although FIG. 10 illustrates generally a single step for forming the curved VTOD, the shaping may take place in several steps, for example, in multiple shaping apparatuses or multiple conditions (e.g., with respect to temperature, force, or the like) employed during the shaping.

In some embodiments, rather than shaping a substantially planar VTOD, the substrate precursor structures may be individually shaped, e.g., in a manner similar to any described elsewhere with respect to shaping the substantially planar VTOD, and a curved VTOD may be formed through assembly of the pre-curved substrate structures. In some embodiments, such pre-curvature may only be partial (partially curved substrate precursor structures) and the subsequent intermediate or partially curved VTOD assembled from such pre-curved substrate precursor structures may be further shaped in a shaping apparatus to form the curved VTOD having the desired curvature.

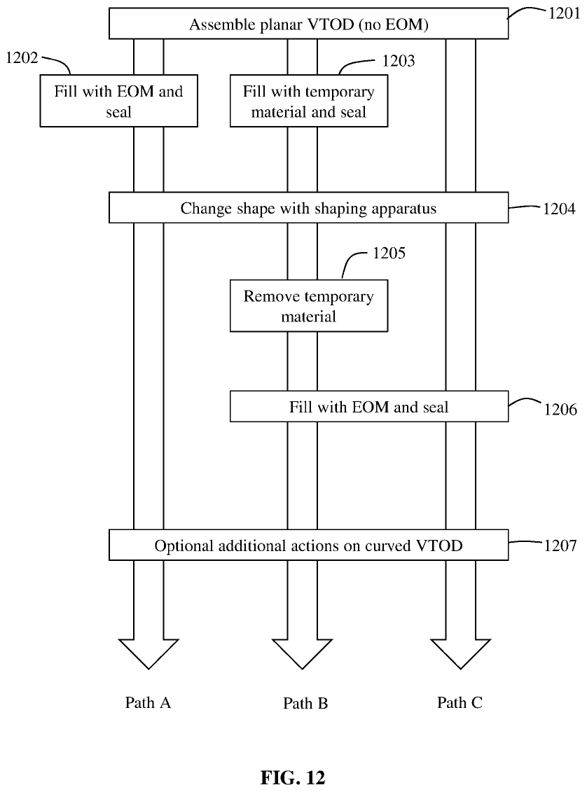

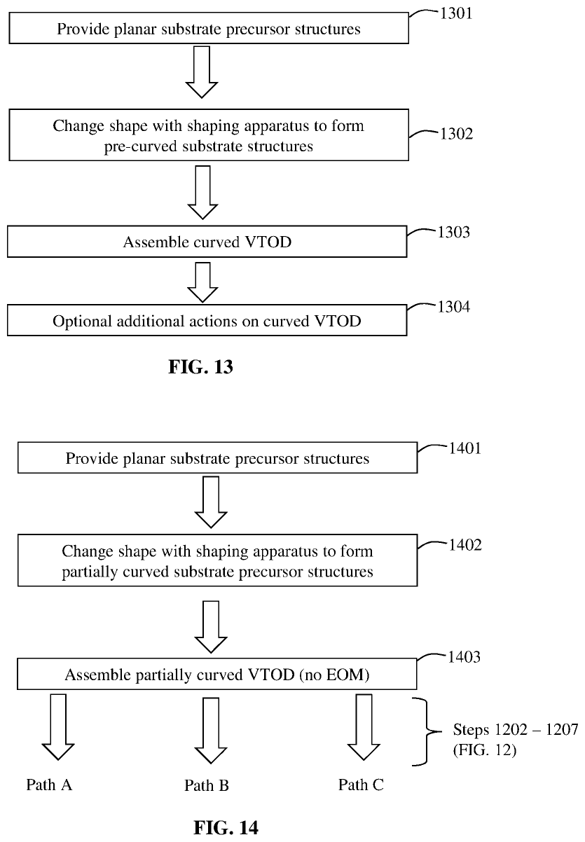

FIGS. 12-14 are block diagrams outlining some non-limiting general steps for forming a curved VTOD according to some embodiments. Turning to FIG. 12, in step 1201, a substantially planar VTOD may be assembled that does not yet include any electro-optic material (“EOM”). From this step, there are shown three general paths: A, B, and C. In Path A, the substantially planar VTOD may be filled with EOM and sealed as step 1202. In Path B, as step 1203, the cell gap of the planar VTOD may instead be filled (fully or partially) with a temporary material which may be a fluid (gas, liquid, gel) or a malleable solid, and optionally sealed. In step 1204, the planar VTOD may be associated with a shaping apparatus which acts on the planar VTOD to cause a change of shape. Step 1204 may be applied after step 1202 with respect to Path A, after step 1203 with respect to Path B, or after step 1201 with respect to Path C. With respect to Path A, the curved VTOD has been formed at step 1204. In some embodiments, in step 1207, additional optional actions may be applied on the curved VTOD. For example, the curved VTOD may be removed from a mold (if used) and undergo additional manufacturing steps which may include, but are not limited to, lamination to a carrier, bonding of electrical connections, application of overcoats, or some other step. In some cases, the curved VTOD after step 1204 may have been laminated to an intended carrier and there is no need to remove it. In Path B, after step 1204, the temporary material may be removed in step 1205. The shaped VTOD may be filled with the electro-optic material and sealed as step 1206, which may be applied after step 1205 for Path B or after step 1204 for Path C. For Path B and C, the curved VTOD has been formed at step 1206 and it may optionally undergo additional actions in step 1207 as previously described. Numerous variations exist to these primary paths. For example, in Paths B and C, the shaped VTOD may be removed from a mold (if used) prior to filling with electro-optic material rather than having removal as part of step 1207.

In FIG. 13, step 1301 includes making or otherwise providing substantially planar substrate precursor structures. As described elsewhere herein, a substrate precursor structure may include, for example, a transparent electrode material such as a hybrid conductor material provided over a substantially planar flexible substrate. In step 1302, the substrate precursor structures are provided in association with a shaping apparatus that acts on them to change their shapes and form pre-curved substrate structures. The pre-curved substrate structures generally retain their new shape and may have the curvature desired for the finished curved VTOD Each substrate precursor structure may be shaped with the same shaping apparatus or with different shaping apparatuses, and may be done sequentially or concurrently. In step 1303, the pre-curved substrate structures may be aligned and assembled to form a curved VTOD. In some cases, this may include removing each pre-curved substrate structure from a mold (if used) and transferring to an assembly station. In step 1304, optional additional actions may be applied to the curved VTOD. For example, the curved VTOD may undergo additional manufacturing steps which may include, but are not limited to, lamination to a carrier, bonding of electrical connections, application of overcoats, or some other step. In some embodiments, one of the pre-curved substrate structures may be formed directly on an intended carrier and the curved VTOD is assembled in place.

In FIG. 14, step 1401 includes making or otherwise providing substantially planar substrate precursor structures. As described elsewhere herein, a substrate precursor structure may include, for example, a transparent electrode material such as a hybrid conductor material provided over a substantially planar flexible substrate. In step 1402, the substrate precursor structures are provided in association with a shaping apparatus that acts on them to change their shapes and form partially curved substrate precursor structures. The partially curved substrate precursor structures generally retain their new shape, but do not yet have the curvature desired for the finished curved VTOD Each substrate precursor substructure may be shaped with the same shaping apparatus or different shaping apparatuses, and may be done sequentially or concurrently. In step 1403, the partially curved substrate precursor structures may be aligned and assembled to form a partially curved VTOD that does not yet include any electro-optic material. In some cases, this may include removing each partially curved substrate precursor structure from a mold (if used) and transferring to an assembly station. At this point, the partially curved VTOD may generally follow the steps and path options as outlined in FIG. 12. That is, step 1403 may replace step 1201, and then steps 1202-1207 corresponding to Paths A, B, and C may be followed as described with respect to FIG. 12.

### Impact of Stretching on Device Performance

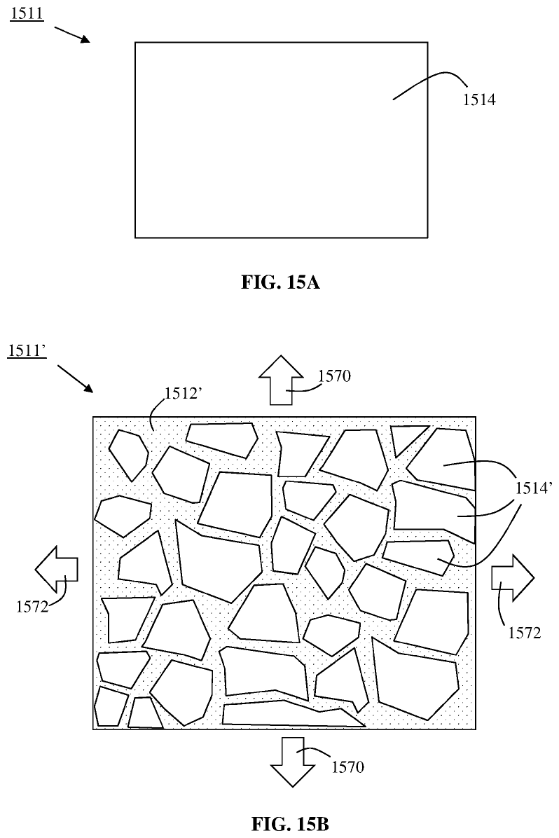

The authors have found that many conventional transparent electrode materials tend to break into disconnected sections or islands when a substrate precursor structure is thermoformed or stretched, for example, with a shaping apparatus. This is particularly true for brittle metal oxide conductors such as ITO or AZO. For example, FIG. 15A is a schematic top view of a substrate precursor structure 1511 having a continuous (conventional) transparent electrode material layer 1514 made, for example, from ITO or AZO before stretching. FIG. 15B is a similar view after stretching along axes 1570 and 1572. The substrate structure 1511′ after stretching shows areas or islands of transparent conductive material 1514′ separated by substrate 1512′. Substrate structure 1511′ will clearly fail electrically due to the discontinuities in the conductive layer. Even optically-transparent thin, continuous metal layers, though potentially more ductile than metal oxides, will eventually lead to similar discontinuities since their ductility and ability to stretch is generally more limited than the substrate itself. Thick metal layers may be able to stretch better than thin metal layers, but thick metal is not transparent and therefore not useful. The failure point with stretching depends in part on the particular electrode material, but with conventional transparent thin metal or TCO layers it is generally less than 10% areal change, sometimes less than 5%, 3%, 2%, or even 1%. In some cases, the areal change may be caused by uniaxial stretching, or alternatively, by biaxial stretching.

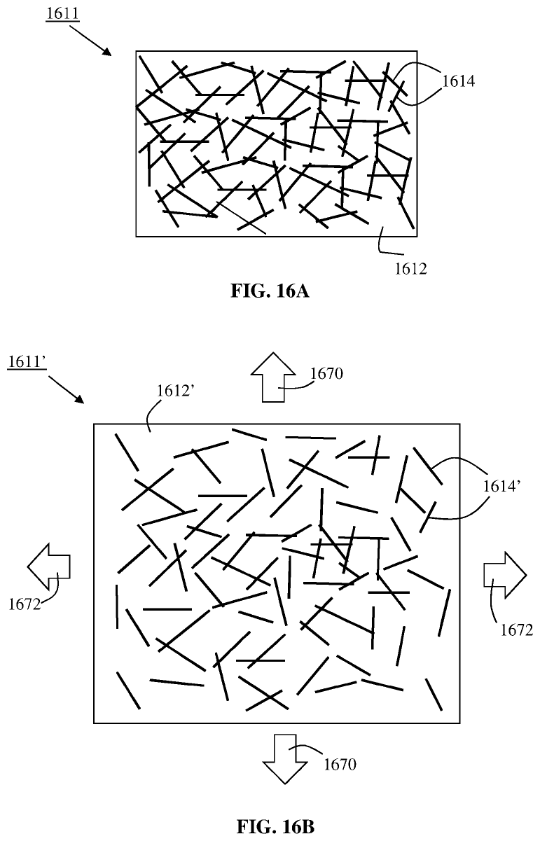

Coatings of conductive particles such as metal nanowires (optionally with a polymeric binder) may offer more stretchability than metal oxides. However, even metal nanowire coatings can fail with sufficient stretching. FIG. 16A is a schematic top view of a substrate precursor structure 1611 having a transparent electrode layer made of metal nanowires 1614, e.g., silver nanowires provided over substrate 1612. The areal density of the nanowires is sufficient so that conductivity across the surface is achieved through random contact from one nanowire to another nanowire. FIG. 16B is a similar view after stretching along axes 1670 and 1672. The substrate structure 1611′ after stretching shows that many of the nanowires 1614′ deposited over stretched substrate 1612′ have been pulled apart so that there are fewer contacts between nanowires. This may increase the resistivity of the electrode. Such resistivity increase may impart higher energy requirements for driving the device or lead to device shorting. Variability in resistance across the electrode may also cause unacceptable nonuniformities in device performance. With enough stretching, this can raise the resistance to a point where conductivity may even be lost across portions of the substrate structure. The failure point with stretching depends in part on the density of the nanowire coating. A dense coating of nanowires may be able to stretch substantially and maintain continuity, but such dense coatings are not transparent and therefore not useful. Even when laid down at sufficiently low levels so that they are “transparent”, they can still impart a haze or an objectional metallic sheen. Conventional transparent coatings of metal nanowires that are acceptable for resistance, haze, transparency and the like, may upon stretching start failing at less than 60% areal change, sometimes less than 50%, 40, 30%, 20%, 10%, or even 5%. In some cases, the areal change may be caused by uniaxial stretching, or alternatively, by biaxial stretching. In some cases, a uniaxial stretch may cause an unacceptable conductivity drop when stretched to 1.6 times its original length. In some cases, a biaxial stretch may cause an unacceptable conductivity drop when stretched to 1.4 times its original length. Note that the foregoing discussion with respect to FIGS. 16A and 16B may in some cases also apply to CNTs.

The authors have found that conductive polymer materials generally have a much higher tolerance to stretching than TCOs or metal nanowires or the like, and can maintain better electrical conductivity across the substrate, even after substantial stretching. However, conductive polymers typically have higher overall resistance than TCOs or conductive particles (e.g., metal nanowires, carbon nanotubes, or the like) at a particular target transmissivity. In some embodiments, to achieve the desired electrical performance, the conductive polymer may absorb too much light.

It has been found, however, that a transparent electrode having a hybrid conductor material as described elsewhere herein can surprisingly provide both good electrical performance and good optical performance even after stretching (shaping). While not being bound by any theory, in some cases it may be that, after stretching, the conductive polymer (which may in some cases include an intrinsically conductive polymer) acts as a bridge between discontinuous areas of supplemental conductor material of the hybrid conductor (e.g., the metal oxide islands, nanowires, or the like). Acting as a bridge, the conductive polymer does not need to be the sole transporter of electrons or sole creator of the electric field—the other conductive material, though less continuous after stretching, may still actively participates in electron transport and electric field generation.

As mentioned, in some embodiments, a substrate structure may deliberately not include a hard coat layer. Most hard coat layers are relatively brittle and upon shaping or stretching may break into islands in a manner similar to that shown with respect to FIG. 15. The formation of islands or fissures in the hard coat may appear as a visible haze to an observer. However, in addition to protecting the substrate from scratches or the like, the hard coat in some cases can protect the substrate from strong organic solvents. It has also been found that coating a polyimide alignment layer over a conductive nanoparticle-based transparent electrode (e.g., metal nanowires, carbon nanotubes, or the like) can cause some damage to the substrate in the absence of a hard coat due to attack by the polyimide solvent on the substrate. This may appear as a haze or cause even worse damage. By adding a conductive polymer to make a hybrid conductor in a manner described elsewhere (e.g., mixing in or overcoating the metal NWs or CNTs with an intrinsically conductive polymer such as PEDOT:PSS), greater resistance to the polyimide solvent may be achieved. In some cases, the conductive polymer may be hydrophilic and not readily soluble in organic solvents such as used for polyimide coating.

### EXAMPLES

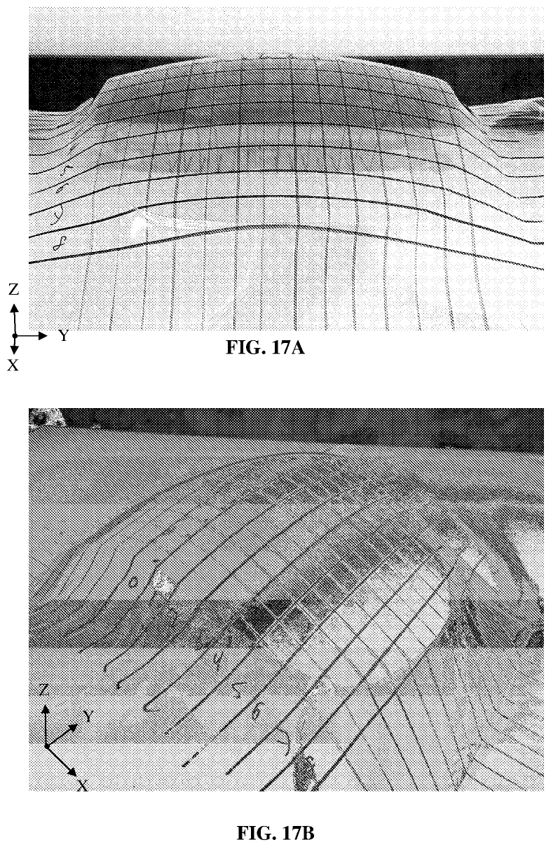

FIGS. 17A and 17B are photographs from two different angles of a substrate precursor structure stretched or thermoformed over a mold to form a curved substrate structure. For perspective, XYZ axes have been added to these figures. The curved substrate structure has a multicurved structure and biaxially stretched. The grid lines were drawn to mark various sections of the curved substrate structure for subsequent sheet resistance measurements. Two different substrate structures were formed over this mold in a similar manner. Near the center of the mold, the surface area of the curved substrate structure was about 100% (˜2×) higher than the original substrate precursor structure.

Comparative A substrate precursor structure included a polycarbonate film 100 microns thick over which a transparent conductive electrode was applied that included silver nanowires using known coating methods. Over the transparent conductive electrode, an alignment layer of polyimide was provided. The substrate did not include a hard coat. Comparative A substrate precursor structure had a resistance of about 40 ohms/square and a transmission of >90% in a range of 400 nm to 730 nm.

Example 1 substrate precursor structure was like that of Comparative A, but further included a layer of a conductive polymer material (PEDOT-based) provided over the layer of silver nanowires to form a transparent hybrid conductor. The conductive polymer layer had a dry thickness on the order of 10's of nanometers. Over the conductive polymer layer, an alignment layer of polyimide was provided. Example 1 substrate precursor structure had a resistance of about 34 ohms/square and a transmission of >90% in a range of 400 nm to 730 nm.

Comparative A and Example 1 were then shaped to form curved substrate structures Comparative A′ and Example 1′, respectively. Shaping was accomplished by the drawing substrates over a mold head at a temperature of about 133° C. and under about 70 PSI air pressure Comparative A′ and Example 1′ were similar in appearance to the images shown in FIGS. 17A and 17B.

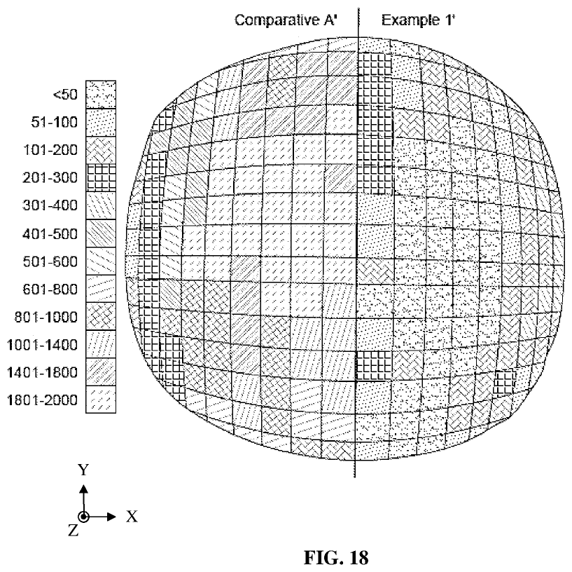

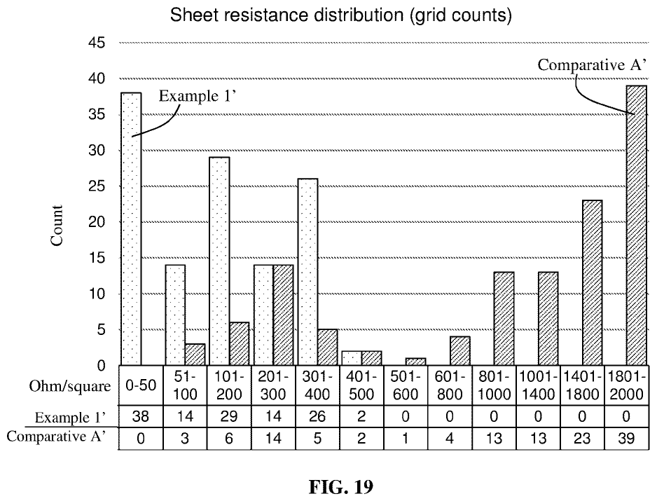

FIG. 18 is a map of sheet resistances across the curved substrate structures, wherein the left half represents the data from Comparative A′ and the right half represents the data from Example 1′. FIG. 19 is a histogram showing a distribution of counts across each sample within a particular sheet resistance range. From both FIG. 18 and FIG. 19, it is clear that Example 1′ is far less resistive than Comparative A′. Comparative A′ shows many regions of sheet resistance higher than about 500 ohm/square, whereas Example 1′ does not have any. Example 1′ includes many grid areas having a sheet resistance of 50 ohm/square or less whereas Comparative A′ has none. Example 1′ has an average sheet resistance of 180 ohm/square with a standard deviation of 140 ohm/square, whereas Comparative A′ has an average sheet resistance of 1155 ohm/square with a standard deviation of 701 ohm/square. That is, Example 1′ is significantly less resistive and has a tighter distribution of resistivity values than Comparative A′.

In some embodiments, the average sheet resistance across a transparent electrode of a curved VTOD may be less than 500 ohm/square, alternatively, less than 300 ohm/square, 250 ohm/square, 200 ohm/square, 150 ohm/square, 100 ohm/square, 75 ohm/square, or 50 ohm/square. In some embodiments, the standard deviation of an average sheet resistance across a transparent electrode is less than 250 ohm/square, alternatively less than 200 ohm/square, 150 ohm/square, 100 ohm/square, 75 ohm/square, 50 ohm/square, or 25 ohm/square. In some embodiments, at least 95% of the area across a transparent electrode of a curved VTOD has a sheet resistance of less than 500 ohm/square, alternatively, less than 300 ohm/square, 250 ohm/square, 200 ohm/square, 150 ohm/square, 100 ohm/square, 75 ohm/square, or 50 ohm/square. In some embodiments, less than 5% of the area across a transparent electrode of a curved VTOD has a sheet resistance of more than 1000 ohm/square, alternatively more than 750 ohm/square, alternatively more than 500 ohm/square, alternatively more than 300 ohm/square.

In some embodiments, the average sheet resistance across a transparent electrode of a curved VTOD is about the same as the average sheet resistance across the transparent electrode material of the corresponding substrate precursor structure prior to shaping. In some embodiments, relative to before shaping, the average sheet resistance of a transparent electrode after shaping is no more than 10× greater, alternatively no more than 8× greater, alternatively no more than 6× greater, alternatively no more than 5× greater, alternatively no more than 4× greater, alternatively no more than 3× greater, alternatively no more than 2× greater, alternatively no more than 1.5× greater, alternatively no more than 1.2× greater.

Although not illustrated in the discussion herein, any of the VTODs may optionally include patterned, individually addressable electrode segments or areas that may be independently activated to provide a localized optical effect. In some cases, a VTOD may have 2 to 50 such segments, alternatively 2 to 10, or alternatively 2 to 6.

Still further embodiments herein include the following enumerated embodiments.
1. A curved variable transmission optical device (“VTOD”) including:
   a first substrate structure including a first transparent electrode provided over a first substrate;
   a second substrate structure including a second transparent electrode provided over a second substrate; and
   an electro-optic material provided between the substrates, wherein each transparent electrode is interposed between its respective substrate and the electro-optic material,
   wherein the first and second substrate structures retain a curved shape such that the VTOD is characterized by at least a first curvature,
   and wherein at least one transparent electrode includes a transparent hybrid conductor having a multilayer or gradient compositional structure, the transparent hybrid conductor including a conductive polymer.
2. The optical device of embodiment 1, wherein the conductive polymer includes an intrinsically conductive polymer selected from a PEDOT, a poly(pyrrole), a polyaniline, a polyphenylene, a poly(acetylene), or a combination thereof.
3. The optical device of embodiment 1 or 2, wherein the conductive polymer includes one or more electrically conductive agents other than a PEDOT, a poly(pyrrole), a polyaniline, a polyphenylene, or a poly(acetylene).
4. The optical device according to any of embodiments 1-3, wherein the transparent hybrid conductor further includes a supplemental conductor selected from a transparent conductive oxide, a metal, metal particles, graphene, carbon nanotubes, or a combination thereof.
5. The optical device of embodiment 4, wherein the metal particles include metal nanowires.
6. The optical device of embodiment 4 or 5, wherein the conductive polymer and the supplemental conductor are provided in a common layer, and wherein a weight percent of the supplemental conductor in a lower portion adjacent the substrate is different than the weight percent in an upper portion adjacent the electro-optic material.
7. The optical device of embodiment 4 or 5, wherein the conductive polymer and the supplemental conductor are provided in different layers.
8. The optical device according to any of embodiments 1-7, wherein the at least one transparent electrode corresponds to the first transparent electrode including a first hybrid conductor, and wherein the second transparent electrode includes a second hybrid conductor.
9. The optical device according to any of embodiments 1-8, wherein the first transparent electrode is substantially the same as the second transparent electrode with respect to composition and thickness.
10. The optical device according to any of embodiments 1-8, wherein the first transparent electrode is different than the second transparent electrode with respect to composition or thickness.
11. The optical device according to any of embodiments 1-10, wherein one or both of the first and second substrates include a polycarbonate.
12. The optical device according to any of embodiments 1-11, wherein the curved shape includes a multicurved surface including a first curvature along a first axis and a second curvature along a second axis.
13. The optical device of embodiment 12, wherein an area of the multicurved surface is in a range of 2 to 400% greater than a virtual area defined by projection of the multicurved surface onto a virtual flat surface.
14. The optical device of embodiment 12, wherein an area of the multicurved surface is in a range of 40 to 200% greater than a virtual area defined by projection of the multicurved surface onto a virtual flat surface.
15. The optical device according to any of embodiments 12-14, wherein the first curvature is different than the second curvature.
16. The optical device according to any of embodiments 12-14, wherein the first curvature is the same as the second curvature.
17. The optical device according to any of embodiments 1-16, wherein the electro-optic material includes a liquid crystal and optionally a dichroic dye.
18. The optical device according to any of embodiments 1-17, further including an alignment layer disposed between the transparent hybrid conductor and the electro-optic material.
19. The optical device of embodiment 18, wherein the alignment layer includes a polyimide.
20. The optical device according to any of embodiments 1-19, wherein the transparent hybrid conductor includes a layer including metal nanowires disposed over the first substrate and a layer including an intrinsically conductive polymer disposed over the metal nanowires.
21. A method of making a curved VTOD, the method including:
   a) providing a substantially planar VTOD in association with a shaping apparatus, the substantially planar VTOD including:
   i) a first substrate precursor structure including a first transparent electrode material provided over a substantially planar first flexible substrate;
   ii) a second substrate precursor structure including a second transparent electrode material provided over a substantially planar second flexible substrate; and
   iii) a cell gap provided between the substrate precursor structures, wherein each transparent electrode is interposed between its respective flexible substrate and the cell gap; and
   b) applying heat, force, or both heat and force to the substantially planar VTOD to cause the first and second substrate precursor structures to permanently change shape in accordance with the shaping apparatus to form a curved VTOD including at least a first curvature,
   wherein at least one transparent electrode material includes a transparent hybrid conductor having a multilayer or gradient compositional structure, the transparent hybrid conductor including a conductive polymer.
22. The method of embodiment 21, wherein the conductive polymer includes an intrinsically conductive polymer selected from a PEDOT, a poly(pyrrole), a polyaniline, a polyphenylene, a poly(acetylene), or a combination thereof.
23. The method of embodiment 21 or 22, wherein the conductive polymer includes one or more electrically conductive agents other than a PEDOT, a poly(pyrrole), a polyaniline, a polyphenylene, or a poly(acetylene).
24. The method according to any of embodiments 21-23, wherein the transparent hybrid conductor further includes a supplemental conductor selected from a transparent conductive oxide, a metal, metal particles, graphene, carbon nanotubes, or a combination thereof.
25. The method of embodiment 24, wherein the metal particles include metal nanowires.
26. The method of embodiment 24 or 25, wherein the conductive polymer and the supplemental conductor are provided in a common layer, and wherein a weight percent of the supplemental conductor in a lower portion adjacent the substrate is different than the weight percent in an upper portion adjacent the electro-optic material.
27. The method of embodiment 24 or 25, wherein the conductive polymer and the supplemental conductor are provided in different layers.
28. The method according to any of embodiments 21-27, wherein the at least one transparent electrode material corresponds to the first transparent electrode material including a first hybrid conductor, and wherein the second transparent electrode material includes a second hybrid conductor.
29. The method according to any of embodiments 21-28, wherein the first transparent electrode material is substantially the same as the second transparent electrode material with respect to composition and thickness.
30. The method according to any of embodiments 21-28, wherein the first transparent electrode material is different than the second transparent electrode with respect to composition or thickness.
31. The method according to any of embodiments 21-30, wherein one or both of the first and second flexible substrates include a polycarbonate.
32. The method according to any of embodiments 21-31, wherein the curved VTOD includes a multicurved surface.
33. The method according to any of embodiments 21-32, wherein a surface area of the curved VTOD is at least 10% higher than a surface area of the substantially planar VTOD, or optionally at least 50% higher.
34. The method according to any of embodiments 21-33, wherein heat is applied such that the temperature of at least one of the first and second flexible substrates is within 20° C. of the at least one substrate Tg or higher, or optionally within 10° C. of the at least one substrate Tg or higher.
35. The method according to any of embodiments 21-34, further including contacting the substantially planar VTOD with a mold.
36. The method of embodiment 35, further including removing the curved VTOD from the mold.
37. The method of embodiment 34, further including permanently laminating the curved VTOD to the mold, wherein the mold includes a device carrier.
38. The method of embodiment 37, wherein the device carrier includes a curved lens, a curved window, a curved sunroof, a curved windshield, a curved visor, or a curved mirror.
39. The method according to any of embodiments 21-38, wherein an average sheet resistance across the hybrid conductor after step (b) is less than 10× greater than an average sheet resistance across the hybrid conductor before step (b), or optionally less than 5× greater.
40. The method according to any of embodiments 21-39, wherein the substantially planar VTOD further includes an alignment layer disposed between the transparent hybrid conductor and the cell gap.
41. The method according to any of embodiments 21-40, wherein the substantially planar VTOD further includes an electro-optic material disposed in the cell gap.
42. The method according to any of embodiments 21-40, further including, after step (b) filling the cell gap with an electro-optic material.
43. A method of making a curved substrate structure including a transparent electrode, the method including:
a) providing a substrate precursor structure into a shaping apparatus, the substrate precursor structure including a transparent electrode material provided over a substantially planar flexible substrate; and
b) applying heat, force, or both heat and force to the substrate precursor structure to cause the substrate precursor structure to permanently change shape in accordance with the shaping apparatus to form the curved substrate structure characterized by at least a first curvature,
wherein the transparent electrode material includes a transparent hybrid conductor having a multilayer or gradient compositional structure, the transparent hybrid conductor including a conductive polymer.
44. The method of embodiment 43, wherein the conductive polymer includes an intrinsically conductive polymer selected from a PEDOT, a poly(pyrrole), a polyaniline, a polyphenylene, a poly(acetylene), or a combination thereof.
45. The method of embodiment 43 or 44, wherein the conductive polymer includes one or more electrically conductive agents other than a PEDOT, a poly(pyrrole), a polyaniline, a polyphenylene, or a poly(acetylene).
46. The method according to any of embodiments 43-45, wherein the transparent hybrid conductor further includes a transparent supplemental conductor selected from a transparent conductive oxide, a metal, metal particles, graphene, carbon nanotubes, or a combination thereof.
47. The method of embodiment 46, wherein the metal particles include metal nanowires.
48. The method of embodiment 46 or 47, wherein the conductive polymer and the supplemental conductor are provided in a common layer, and wherein a weight percent of the supplemental conductor in a lower portion adjacent the substrate is different than the weight percent in an upper portion adjacent the electro-optic material.
49. The method of embodiment 46 or 47, wherein the conductive polymer and the supplemental conductor are provided in different layers.
50. The method according to any of embodiments 43-49, wherein the flexible substrate includes a polycarbonate.
51. The method according to any of embodiments 43-50, wherein the curved substrate structure includes a multicurved surface.
52. The method according to any of embodiments 43-41, wherein a surface area of the curved substrate structure is at least 10% higher than a surface area of the substrate precursor structure, or optionally at least 50% higher.
53. The method according to any of embodiments 43-52, wherein heat is applied such that the temperature of the flexible substrate is within 20° C. of the substrate Tg or higher, or optionally within 10° C. of the substrate Tg or higher.
54. The method according to any of embodiments 43-53, further including contacting the substrate precursor structure with a mold.
55. The method according to any of embodiments 43-54, wherein an average sheet resistance across the hybrid conductor after step (b) is less than 10× greater than an average sheet resistance across the hybrid conductor before step (b).
56. The method according to any of embodiments 43-51, wherein the substrate precursor structure further includes an alignment layer disposed over the transparent electrode material.
57. A curved variable transmission optical device (“VTOD”) including:
a first substrate structure including a first transparent electrode provided over a first substrate;
a second substrate structure including a second transparent electrode provided over a second substrate; and
an electro-optic material provided between the substrates, wherein each transparent electrode is interposed between its respective substrate and the electro-optic material,
wherein at least one of the first and second substrate structures is made by the method according to any of embodiments 43-56.
58. An article of manufacture including the VTOD according to any of embodiments 1-20, or 57, or including the VTOD made by the method according to any of embodiments 21-42, wherein the article of manufacture includes a camera filter, eyewear, a visor, goggles, a face shield, an AR/VR headset, a near-eye display, a window, a windshield, a sunroof, a heads-up display, or an optical instrument.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of example embodiments of the invention has been presented for the purposes of illustration and description. It is not intended to be exhaustive or to limit the invention to the precise form described, and many modifications and variations are possible in light of the teaching above.

In the preceding description, for the purposes of explanation, numerous details have been set forth in order to provide an understanding of various embodiments of the present technology. It will be apparent to one skilled in the art, however, that certain embodiments may be practiced without some of these details, or with additional details.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Additionally, details of any specific embodiment may not always be present in variations of that embodiment or may be added to other embodiments.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither, or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a method” includes a plurality of such methods and reference to “the layer” includes reference to one or more layers and equivalents thereof known to those skilled in the art, and so forth. The invention has now been described in detail for the purposes of clarity and understanding. However, it will be appreciated that certain changes and modifications may be practiced within the scope of the appended claims.

All publications, patents, and patent applications cited herein are hereby incorporated by reference in their entirety for all purposes. None is admitted to be prior art.

1. A curved variable transmission optical device (“VTOD”) comprising:
a first substrate structure comprising a first transparent electrode provided over a first substrate;
a second substrate structure comprising a second transparent electrode provided over a second substrate; and
an electro-optic material provided between the substrates, wherein each transparent electrode is interposed between its respective substrate and the electro-optic material,
wherein the first and second substrate structures retain a curved shape such that the VTOD is characterized by at least a first curvature,
and wherein at least one transparent electrode comprises a transparent hybrid conductor having a multilayer or gradient compositional structure, the transparent hybrid conductor comprising a conductive polymer.

2. The optical device of claim 1, wherein the conductive polymer comprises a PEDOT, a poly(pyrrole), a polyaniline, a polyphenylene, a poly(acetylene), or a combination thereof.

3. The optical device of claim 1, wherein the conductive polymer comprises a polymeric material and one or more electrically conductive agents.

4. The optical device of claim 1, wherein the transparent hybrid conductor further comprises a supplemental conductor selected from a transparent conductive oxide, a metal, metal particles, metal nanowires, graphene, carbon nanotubes, or a combination thereof.

5. The optical device of claim 4, wherein the conductive polymer and the supplemental conductor are provided in a common layer, and wherein a weight percent of the supplemental conductor in a portion adjacent the substrate is different than the weight percent in a portion adjacent the electro-optic material.

6. The optical device of claim 4, wherein the conductive polymer and the supplemental conductor are provided in different layers.

7. The optical device of claim 1, wherein the at least one transparent electrode corresponds to the first transparent electrode comprising a first hybrid conductor, and wherein the second transparent electrode comprises a second hybrid conductor.

8. The optical device of claim 1, wherein the first transparent electrode is substantially the same as the second transparent electrode with respect to composition and thickness.

9. (canceled)

10. (canceled)

11. The optical device of claim 1, wherein the curved shape comprises a multicurved surface comprising a first curvature along a first axis and a second curvature along a second axis, and wherein the first and second curvatures are different or the same.

12. The optical device of claim 11, wherein an area of the multicurved surface is in a range of 2 to 400% greater than a virtual area defined by projection of the multicurved surface onto a virtual flat surface.

13. The optical device of claim 1, wherein the electro-optic material comprises a liquid crystal.

14. (canceled)

15. (canceled)

16. An article of manufacture including comprising the curved VTOD of claim 1, wherein the article of manufacture comprises a camera filter, eyewear, a visor, goggles, a face shield, an AR/VR headset, a near-eye display, a window, a windshield, a sunroof, a heads-up display, or an optical instrument.

17. A method of making a curved VTOD, the method comprising:
a) providing a substantially planar VTOD in association with a shaping apparatus, the substantially planar VTOD comprising:
i) a first substrate precursor structure comprising a first transparent electrode material provided over a substantially planar first flexible substrate;
ii) a second substrate precursor structure comprising a second transparent electrode material provided over a substantially planar second flexible substrate; and
iii) a cell gap provided between the substrate precursor structures, wherein each transparent electrode is interposed between its respective flexible substrate and the cell gap; and
b) applying heat, force, or both heat and force to the substantially planar VTOD to cause the first and second substrate precursor structures to permanently change shape in accordance with the shaping apparatus to form a curved VTOD comprising at least a first curvature,
wherein at least one transparent electrode material comprises a transparent hybrid conductor having a multilayer or gradient compositional structure, the transparent hybrid conductor comprising a conductive polymer.

18. The method of claim 17, wherein: (i) the conductive polymer comprises a PEDOT, a poly(pyrrole), a polyaniline, a polyphenylene, a poly(acetylene), or a combination thereof; (ii) the transparent hybrid conductor further comprises a supplemental conductor selected from a transparent conductive oxide, a metal, metal particles, metal nanowires, graphene, carbon nanotubes, or a combination thereof, or (iii) both (i) and (ii).

19. (canceled)

20. (canceled)

22. (canceled)

23. The method of claim 17, wherein i) the curved VTOD comprises a multicurved surface, ii) a surface area of the curved VTOD is at least 10% higher than a surface area of the substantially planar VTOD, or iii) both (i) and (ii).

24. (canceled)

25. (canceled)

26. (canceled)

27. The method of claim 17, further comprising filling the cell gap with an electro-optic material either before or after step (b).

28. (canceled)

29. (canceled)

30. (canceled)

31. (canceled)

32. The optical device of claim 1, wherein the transparent hybrid conductor comprises a layer including metal nanowires disposed over the first substrate and a layer comprising an intrinsically conductive polymer disposed over the metal nanowires.

33. The optical device of claim 1, wherein the transparent hybrid conductor comprises a layer including a transparent conductive oxide disposed over the first substrate and a layer comprising the conductive polymer disposed over the transparent conductive oxide, wherein the conductive polymer comprises (i) an intrinsically conductive polymer, (ii) metal nanowires, or (iii) both (i) and (ii).

34. The optical device of claim 1, wherein the first and second substrate structures retain the curved shape by (i) application of heat, force, or both heat and force, (ii) lamination to a carrier, or (iii) both (i) and (ii).

35. The optical device of claim 1, wherein the first and second substrate structures have been stretched to form the curved shape.

36. The method of claim 17, wherein the force comprises stretching.

37. The method of claim 17, wherein the shaping apparatus comprises a carrier intended to be part of a final manufacturing product, the method further comprising laminating the substantially planar VTOD to the carrier thereby forming the curved VTOD on the carrier.

38. The method of claim 28, wherein the force comprises stretching.

39. The method of claim 28, wherein the shaping apparatus comprises a carrier intended to be part of a final manufacturing product, the method further comprising laminating the substrate precursor structure to the carrier thereby forming the curved substrate structure on the carrier.
